(19) United States
(12) Patent Application Publication
(10) Pub. No.: US 2010/0126222 A1
(43) Pub. Date: May 27, 2010

(54) METHOD AND APPARATUS FOR FORMING AND CUTTING A SHAPED ARTICLE FROM A SHEET OF MATERIAL

(76) Inventor: Thierry Luc Alain Dannoux, Avon (FR)

Correspondence Address: CORNING INCORPORATED, SP-TI-3-1, CORNING, NY, 14831, US

(21) Appl. No.: 12/277,550

(22) Filed: Nov. 25, 2008

(51) Int. Cl. C03B 21/04

(52) U.S. Cl. 65/105; 65/177

(57) ABSTRACT

An apparatus for forming shaped articles from a sheet of material includes a first mold having a mold surface and a network of gutters formed in the mold surface. The network of gutters has a network gutter profile and defines an array of islands on which an array of bumps is formed. Each of the bumps has a surface with a shaped profile. The apparatus also includes a second adapted for positioning on the mold surface. The second mold has a network of protuberances defining a plurality of cavities. Each of the cavities is sized to overlap one of the bumps of the first mold. The network of protuberances has a network protuberance profile complementary to the network gutter profile.

### FIELD

The invention relates generally to methods and apparatus for forming shaped articles. More specifically, the invention relates to a method and an apparatus for reforming a thin sheet of material into a shaped article.

### BACKGROUND

Molding is a common technique used to make shaped objects. Precision molding is suitable for forming shaped glass articles, particularly when the final glass article is required to have a high dimensional accuracy and a high-quality surface finish. In precision molding, a glass preform having an overall geometry similar to that of the final glass article is pressed between a pair of mold surfaces to form the final glass article. The process requires high accuracy in delivery of the glass preform to the molds as well as precision ground and polished mold surfaces and is therefore expensive.

Press molding based on pressing a gob of molten glass into a desired shape with a plunger can be used to produce shaped glass articles at a relatively low cost, but generally not to the high tolerance and optical quality achievable with precision molding. Where the molten glass has to be spread thinly to make a thin-walled glass article having complex curvatures, the molten glass may become cold, or form a cold skin, before reaching the final desired shape. Shaped glass articles formed from press molding a gob of molten glass may exhibit one or more of shear marking, warping, optical distortion due to low surface quality, and overall low dimensional precision.

### SUMMARY

In one aspect, the invention relates to an apparatus for forming shaped articles from a sheet of material which comprises a first mold having a mold surface and a network of gutters formed in the mold surface. The network of gutters has a network gutter profile and defines an array of islands on which an array of bumps is formed. Each of the bumps has a surface with a shaped profile. The apparatus further includes a second mold adapted for positioning on the mold surface. The second mold has a network of protuberances defining a plurality of cavities. Each of the cavities is sized to overlap one of the bumps of the first mold. The network of protuberances has a network protuberance profile complementary to the network gutter profile.

In another aspect, the invention relates to an apparatus for forming a shaped article from a sheet of material which comprises a first mold having a mold surface and a network of gutters formed in the mold surface. The network of gutters has a network gutter profile and defines an island on which a bump is formed. The bump has a surface with a shaped profile substantially matching a surface profile of the shaped article. The apparatus further includes a second mold adapted for positioning on the mold surface. The second mold has a network of protuberances defining a cavity sized to overlap the bump. The network of protuberances has a network protuberance profile complementary to the network gutter profile.

In another aspect, the invention relates to a method of making a shaped article which comprises positioning a sheet of material on a mold surface of a first mold such that a first portion of the sheet overlies a network of gutters in the mold surface and a second portion of the sheet of material overlies a bump on the mold surface. The network of gutters defines an island on which the bump is formed, and the bump has a surface with a shaped profile. The method further includes positioning a second mold having a network of protuberances defining a cavity on the sheet of material such that the network of protuberances contacts the first portion of the sheet of material and the cavity overlaps the bump. The method further includes pressing the network of protuberances against the sheet of material. The pressing results in thinning out of the sheet of material between the first portion and the second portion of the sheet of material, squeezing of excess sheet of material from the thinning out into the network of gutters, and molding of the second portion of the sheet of material to the bump, thereby forming the shaped article.

Other features and advantages of the invention will be apparent from the following description and the appended claims.

### BRIEF DESCRIPTION OF DRAWINGS

The accompanying drawings, described below, illustrate typical embodiments of the invention and are not to be considered limiting of the scope of the invention, for the invention may admit to other equally effective embodiments. The figures are not necessarily to scale, and certain features and certain views of the figures may be shown exaggerated in scale or in schematic in the interest of clarity and conciseness.

FIG. 1 is a cross-sectional view of an apparatus for forming a shaped article.

FIG. 2 is a top view of the bottom mold of an apparatus for forming a shaped article.

FIG. 3 is a bottom view of the top mold of an apparatus for forming a shaped article.

FIG. 4 is a top view of a bottom mold of an apparatus for forming a plurality of shaped articles.

FIG. 5 is a bottom view of a top mold of an apparatus for forming a plurality of shaped articles.

FIG. 6 shows a sheet of material positioned on a bottom mold of an apparatus for forming a shaped article.

FIG. 7 shows a top mold suspended over the sheet of material of FIG. 6.

FIG. 8 shows the top mold of FIG. 7 in contact with the sheet of material of FIG. 6.

FIG. 9 shows a shaped article formed between a top mold and a bottom mold of an apparatus for forming a shaped article.

### DETAILED DESCRIPTION

The invention will now be described in detail with reference to a few embodiments, as illustrated in the accompanying drawings. In describing the embodiments, numerous specific details are set forth in order to provide a thorough understanding of the invention. However, it will be apparent to one skilled in the art that the invention may be practiced without some or all of these specific details. In other instances, well-known features and/or process steps have not been described in detail so as not to unnecessarily obscure the invention. In addition, like or identical reference numerals are used to identify common or similar elements.

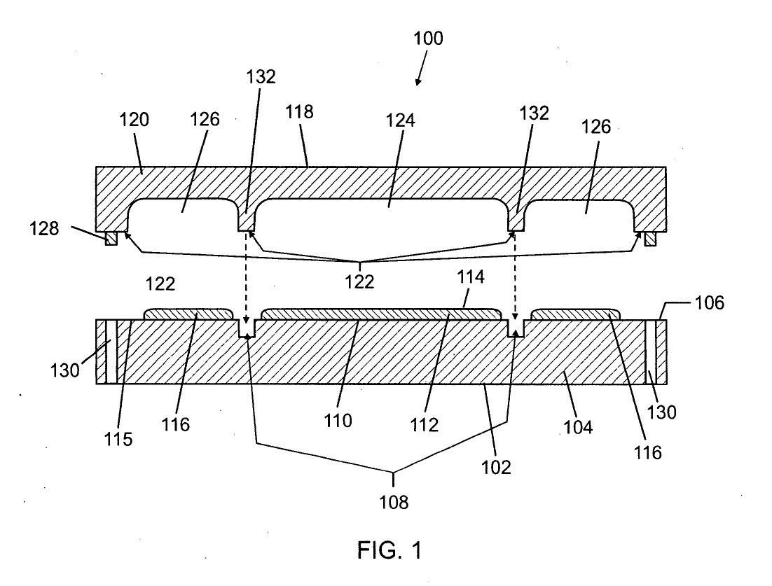

FIG. 1 is a cross-sectional view of an apparatus 100 for making a shaped article. In general, a shaped article will be considered herein as having a top surface with a top surface profile and a bottom surface with a bottom surface profile. The terms “top surface” and “bottom surface” are arbitrary. Each of the top surface and bottom surface may be the inner or outer surface (front or back surface) of the shaped article.

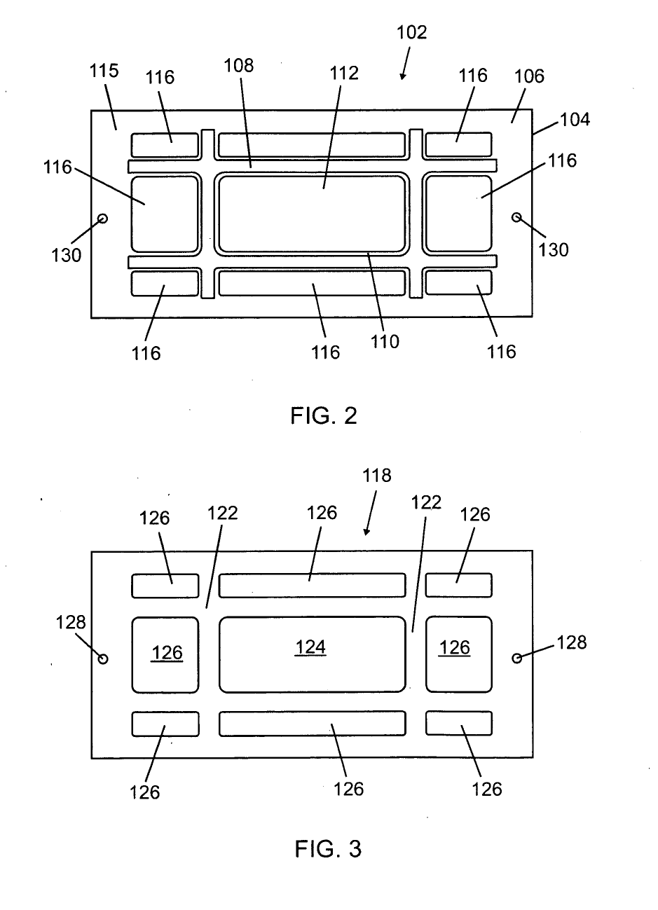

Apparatus 100 includes a bottom mold 102 having a base portion 104, which may be generally planar. Base portion 104 has a mold surface 106 in which a network of gutters 108 is formed. The gutters in the network of gutters 108 extend from the mold surface 106 into the base portion 104. The network of gutters 108 defines an island 110 on the mold surface 106. A bump 112 is formed on the island 110. The bump 112 has an outer surface 114 characterized by a shaped profile matching the top surface profile or bottom surface profile of the shaped article to be formed. The network of gutters 108 has a gutter profile, which is more clearly shown in FIG. 2. It should be noted that the shaped profile of the bump 112 and the gutter profile of the gutter 108 are not limited to the examples depicted in FIGS. 1 and 2. For example, the shaped profile of the bump 112 may be convex and smooth, as shown in FIG. 1, or may be more complex, e.g., including concave and/or textured portions. In general, the shaped profile of the bump 112 and the gutter profile of the network of gutters 108 will depend on the shape of the shaped article to be formed.

Referring to FIGS. 1 and 2, the network of gutters 108 also defines an island 115 on the mold surface 106. The island 115 encircles the island 110 and is separated from the island 110 by the network of gutters 108. Side bumps 116 are formed on the island 115. The side bumps 116 form an arrangement of bumps encircling the bump 112. Like the bump 112, the side bumps 116 also have shaped profiles. However, the shaped profiles of the side bumps 116 do not have to match the top surface profile or bottom surface profile of a shaped article to be formed using apparatus 100 because shapes formed by the side bumps 116 would generally be discarded.

Referring to FIG. 1, apparatus 100 further includes a top mold 118. In one non-limiting example, the top mold 118 includes a base portion 120 and a network of protuberances 122 formed on the base portion 120. The network of protuberances 122 defines a first cavity 124 sized to overlap (fit over) the bump 112. The network of protuberances 122 may further define a plurality of cavities 126, each of which may be sized to overlap (fit over) one of the side bumps 116. In general, the arrangement of the cavities 124, 126 defined by the network of protuberances 122 is complementary with the arrangement of the bumps 112, 116 in the bottom mold 102. This means that when the top mold 118 is aligned with the bottom mold 102 (as indicated by the broken arrows in FIG. 1), the cavities 124, 126 are aligned with and in a position to overlap the bumps 112, 116, respectively. This is better seen by comparing FIG. 2 with FIG. 3, where FIG. 2 shows a top view of the bottom mold 102 and FIG. 3 shows a bottom view of the top mold 118. Also, the network of protuberances 122 has a protuberance profile (FIG. 3) that is complementary to the gutter profile (FIG. 2) of the network of gutters 108. This means that when the top mold 118 is aligned with the bottom mold 102 (as indicated by the broken arrows in FIG. 1), the protuberances 122 are also aligned with the gutters 108, and the gutters 108 are in a position to accept the protuberances 122.

Still referring to FIG. 1, the top mold 118 is brought into contact with the bottom mold 102, with the network of protuberances 122 resting on the mold surface 106, in order to form a shaped article. When forming the shaped articles, the cavities 124, 126 fit over the bumps 112, 116, respectively. Alignment features may be included in apparatus 100 to facilitate alignment of the cavities 124, 126 with the bumps 112, 116, respectively. In one non-limiting example, the alignment features may include a pin 128 formed on the top mold 118 and a hole 130 formed on the bottom mold 102 to receive the pin. Alternatively, the pin 128 may be formed on the bottom mold 102 and the hole 130 formed in the top mold 118 to fit over the pin 128. A plurality of alignment features 128, 130 may be provided in the top mold 118 and bottom mold 102 as desired. The protuberances 132 on the inside of the network of protuberances 122 may be sized to slide into the network of gutters 108 when the top mold 118 is mounted on the mold surface 106 of the bottom mold 102. Alternatively, the protuberances 132 on the inside of the network of protuberances 122 may simply rest on the islands 110, 115.

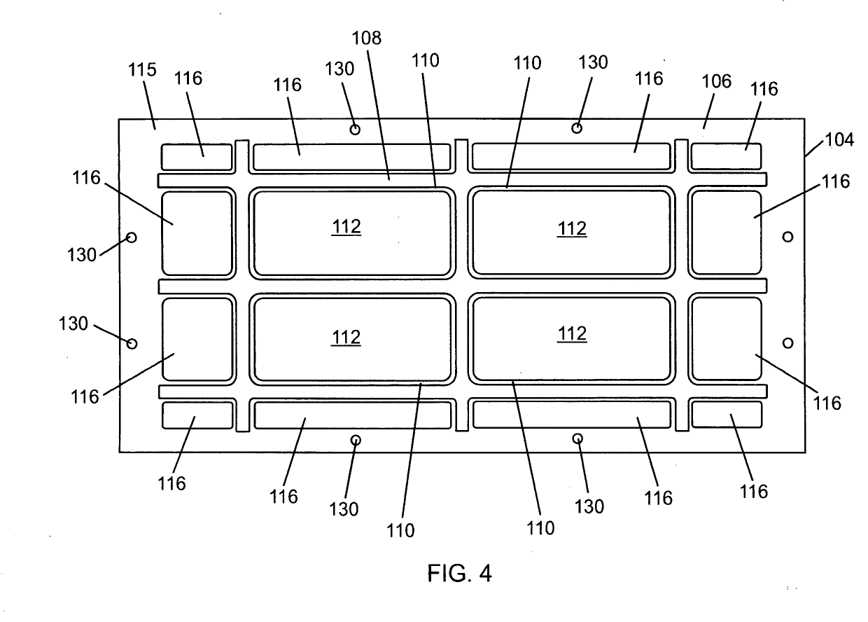

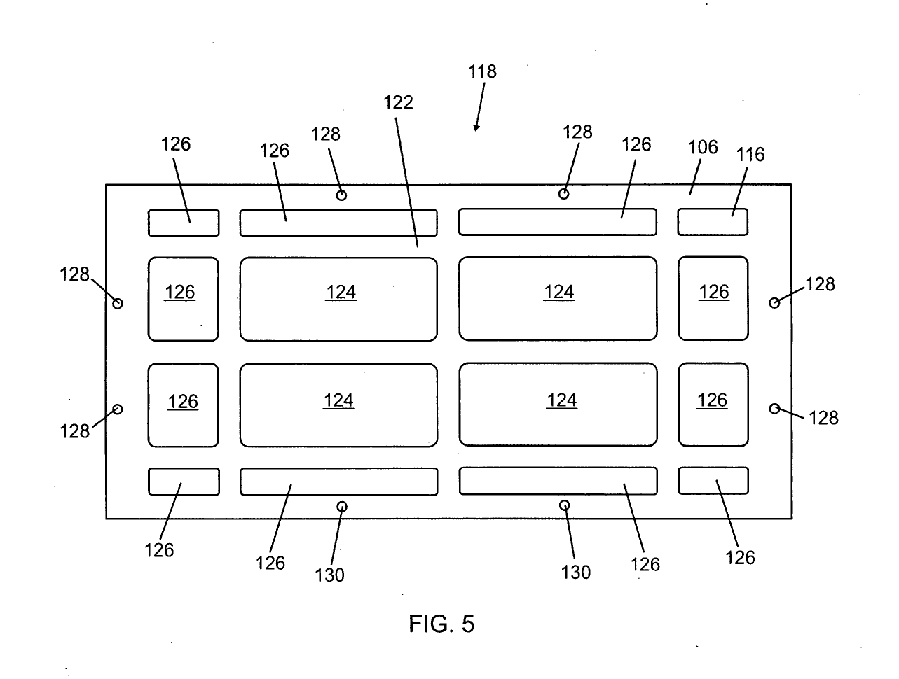

As illustrated in FIG. 4, bottom mold 102 may include an array of islands 110 on which bumps 112 are formed. Each bump 112 shown in FIG. 4 has a shaped profile as described above. The shaped profile of the bumps 112 may be the same or may be different. Similarly, as illustrated in FIG. 5, top mold 118 may include a plurality of cavities 122 sized to overlap the bumps (112 in FIG. 4), where the plurality of cavities 122 are defined by the network of protuberances 122. The bottom mold 102 shown in FIG. 4 and top mold 118 shown in FIG. 5 allow multiple shaped articles to be formed in a single operation or step.

The bottom mold 102 and top mold 118 in FIGS. 1-5 may be made of a suitable heat resistant material, i.e., one that would not interact with the material to be used in forming the shaped article(s). Typically, the mold material is selected such that there isn't a large mismatch in coefficient of thermal expansion (CTE) between the mold material and the material of the shaped article(s). In one non-limiting example, the mold material is selected such that the absolute CTE mismatch between the mold material and the material of the shaped article(s) is less than about 1×10⁻⁶/° C. In one non-limiting example, the shaped article is made of a glass-based material, such as glass or glass-ceramic. For glass-based materials, examples of suitable material for the molds include, but are not limited to, stainless steel and graphite. The surface of the molds including the shaping profiles may be coated with a non-stick material, such as, but not limited to, boron nitride, calcium hydroxide, and carbon soot to facilitate separation of the shaped article from the molds.

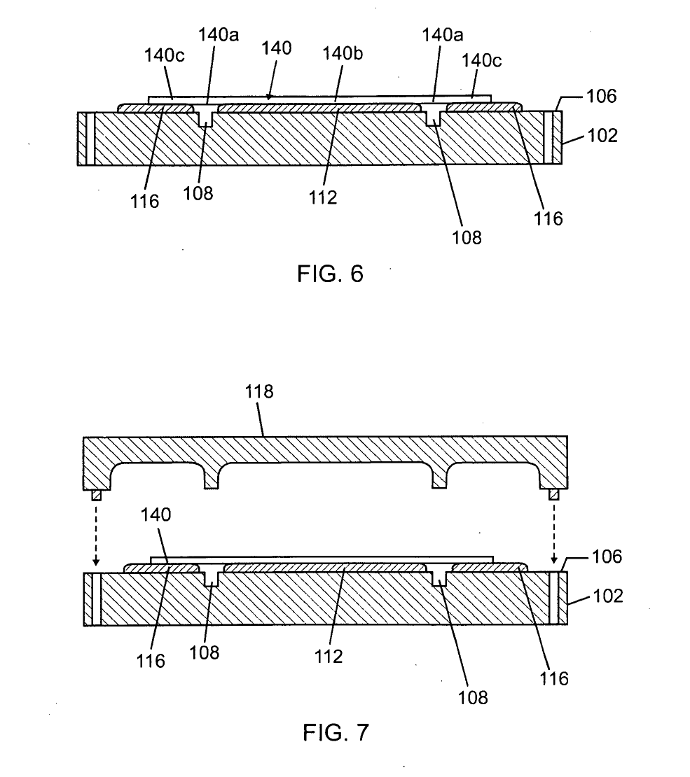

FIGS. 6 and 7 illustrate a method of making a shaped article. In FIG. 6, a sheet of material 140 is placed on the bottom mold 102. In one non-limiting example, the sheet of material 140 is a sheet of glass-based material, e.g., a sheet of glass or a sheet of glass-ceramic. At this point, sheet 140 is a flat piece of material (as opposed to a preform having a shape that approximates the shape of the shaped article to be formed). Sheet 140 is placed on the bottom mold 102 such that a first portion 140a of the sheet 140 overlies the network of gutters 108, a second portion 140b of the sheet 140 overlies the bump 112, and a third portion 140c of the sheet 140 overlies the side bumps 116. In this position, the sheet 140 is heated to a temperature above the softening temperature of the glass-based material. Typically, heating of the sheet 140 also includes heating of the bottom mold 102. In one non-limiting example, sheet 140 is heated to a temperature of about 10° C. higher than the softening point of the glass-based material. Sheet 140 may also be heated prior to being placed on the bottom mold 102, but not necessarily to a temperature above the softening temperature of the glass-based material. Additional heating of the preheated sheet 140 may be used to achieve the desired temperature at which the sheet 140 will be molded to form shaped articles.

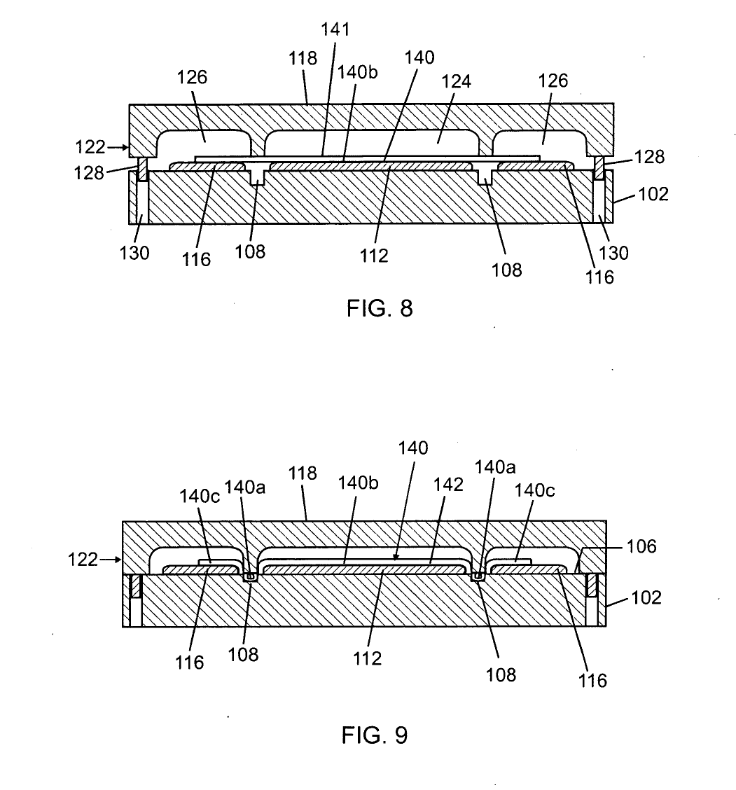

FIG. 7 shows the top mold 118 suspended over the sheet 140. It is noted that the top mold 118 may be suspended over the sheet 140 prior to or after heating the sheet 140. In the former case, the top mold 118 may be heated along with the sheet 140. In FIG. 8, the top mold 118 is brought into contact with the sheet 140, with the cavities 124, 126 aligned with the bumps 112, 116, respectively. The pins 128 in the top mold 118 may be aligned with the holes 130 to achieve the proper alignment between the top mold 118 and the bottom mold 102. When properly aligned, the cavity 124 protects the upper surface 141 of the second sheet portion 140b overlying the bump 112 from being touched by the network of protuberances 122. The cavity 124 is deep enough that there is clearance between its wall and the upper surface 141 both before and after the second sheet portion 140b is molded to the bump 112, as will be described below. In other words, the height of the cavity 124 is greater than the sum of the height of the bump 112 and thickness of the sheet 140. This allows the upper surface 141 of the second sheet portion 140b, which will become a surface of a shaped article, to remain in a pristine condition.

In FIG. 9, the network of protuberances 122 is pressed against the sheet 140. If top mold 118 is not sufficiently heavy, such pressing may include applying an external load to the top mold 118. The network of protuberances 122 is pressed against the sheet 140 until the network of protuberances 122 encounters the mold surface 106 on the bottom mold 102. Several events occur during this pressing. One event is molding of the sheet 140 to the bumps 112, 116 as the sheet 140 is being pushed downwardly and around the periphery of the bumps 112, 116 by the network of protuberances 122. Another event is thinning of the sheet 140 in the region where it is in contact with the network of protuberances 122. This region is between the first portion 140a of the sheet 140 which overlies the network of gutters 108 and the second portion 140b of the sheet 140 which overlies the bump 112. This region is also between the first portion 140a of the sheet 140 which overlies the network of gutters 108 and the third portion 140c of the sheet 140 which overlies the side bumps 116. The thinning path will generally trace the edges of the network of gutters 108 (refer to FIG. 2 for the network gutter profile). In some examples, the localized thinning out of the sheet 140 effectively results in cutting or shearing of the sheet 140 along the thinning path. Such cutting or shearing may be achieved by applying enough force to the network of protuberances 122 to pinch the sheet 140 between the network of protuberances 122 and the mold surface 106. In some examples, the protuberances in the network 122 may slide into the gutters in the network 108, creating a scissor-like action that shears the sheet 140. Another event that occurs during pressing of the sheet 140 is that the excess sheet material produced by the thinning out of the sheet 140 is squeezed into the network of gutters 108.

The portion of the sheet 140 molded onto the bump 112 becomes the shaped article 142. After pressing, the shaped article 142 is allowed to cool down between the top mold 118 and the bottom mold 102. The shaped article 142 may be allowed to cool down to a temperature below the strain point of the glass-based material from which the shaped article is made. For example, the shaped article may be cooled to a temperature of about 50° C. below the glass strain point. Then, the top mold 118 is separated from the bottom mold 102. Next, the shaped article 142 is popped from the surrounding sheet of material. Additional processing of the shaped article 142 may include annealing the shaped article 142 and chemically strengthening the shaped article 142. The shaped article may also be finished, e.g., by fire polishing, to improve its surface quality. The method described can be used to form a plurality of discrete shaped articles 142 in a single operation or step using the top mold 118 in FIG. 5 and the bottom mold 102 in FIG. 4. Further, a stack of apparatus 100 as explained above can be used to make several discrete shaped articles 142 in a single operation or step.

In one non-limiting example, the sheet 140 used in making the shaped article is made of a glass-based material that can be chemically strengthened by ion-exchange. Typically, the presence of small alkali metal ions such as Li⁺ and Na⁺ in the glass structure that can be exchanged for larger alkali metal ions such as K⁺ render the glass composition suitable for chemical strengthening by ion-exchange. The base glass composition can be variable. For example, U.S. patent application Ser. No. 11/888,213, assigned to the instant assignee, discloses alkali-aluminosilicate glasses that are capable of being strengthened by ion-exchange and down-drawn into sheets. The glasses have a melting temperature of less than about 1650° C. and a liquidus viscosity of at least about 1.3×10⁵ Poise and, in one embodiment, greater than about 2.5×10⁵ Poise. The glasses can be ion-exchanged at relatively low temperatures and to a depth of at least 30 μm. Compositionally the glass comprises: 64 mol %≦SiO₂≦68 mol %; 12 mol %≦Na₂O≦16 mol %; 8 mol %≦Al₂O₃≦12 mol %; 0 mol %≦B₂O₃≦3 mol %; 2 mol %≦K₂O≦5 mol %; 4 mol %≦MgO≦6 mol %; and 0 mol %≦CaO≦5 mol %, wherein: 66 mol %≦SiO₂+B₂O₃+CaO≦69 mol %; Na₂O+K₂O+B₂O₃+MgO+CaO+SrO>10 mol %; 5 mol %≦MgO+CaO+SrO≦8 mol %; (Na₂O+B₂O₃)−Al₂O₃≦2 mol %; 2 mol %≦Na₂O−Al₂O₃≦6 mol %; and 4 mol %≦(Na₂O+K₂O)−Al₂O₃≦10 mol %.

The ion-exchange process typically occurs at an elevated temperature range that does not exceed the transition temperature of the glass. The glass is dipped into a molten bath comprising a salt of an alkali metal, the alkali metal having an ionic radius that is larger than that of the alkali metal ions contained in the glass. The smaller alkali metal ions in the glass are exchanged for the larger alkali metal ions. For example, a glass sheet containing sodium ions may be immersed in a bath of molten potassium nitrate (KNO₃). The larger potassium ions present in the molten bath will replace smaller sodium ions in the glass. The presence of the large potassium ions at sites formerly occupied by sodium ions creates a compressive stress at or near the surface of the glass. The glass is then cooled following ion exchange. The depth of the ion-exchange in the glass is controlled by the glass composition. For potassium/sodium ion-exchange process, for example, the elevated temperature at which the ion-exchange occurs can be in a range from about 390° C. to about 430° C., and the time period for which the sodium-based glass is dipped in a molten bath comprising a salt of potassium can range from about 7 up to about 12 hours (with less time being required at high temperatures, and more time being required at lower temperatures). In general, the deeper the ion-exchange, the higher the surface compression and the stronger the glass can be.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An apparatus for forming shaped articles from a sheet of material, comprising:
a first mold having a mold surface and a network of gutters formed in the mold surface, the network of gutters having a network gutter profile and defining an array of islands on which an array of bumps is formed, each of the bumps having a surface with a shaped profile; and
a second mold adapted for positioning on the mold surface, the second mold having a network of protuberances defining a plurality of cavities, each of the cavities sized to overlap one of the bumps of the first mold, the network of protuberances having a network protuberance profile complementary to the network gutter profile.

2. The apparatus of claim 1, wherein a height of each of the cavities is greater than a height of the bump it is sized to overlap.

3. The apparatus of claim 1, further comprising complementary alignment features located on the first mold and the second mold.

4. The apparatus of claim 1, wherein at least a portion of the bumps have a surface with a shaped profile substantially matching a surface profile of a shaped article.

5. An apparatus for forming a shaped article from a sheet of material, comprising:
a first mold having a mold surface and a network of gutters formed in the mold surface, the network of gutters having a network gutter profile and defining an island on which a bump is formed, the bump having a surface with a shaped profile substantially matching a surface profile of the shaped article; and
a second mold adapted for positioning on the mold surface, the second mold having a network of protuberances defining a cavity sized to overlap the bump, the network of protuberances having a network protuberance profile complementary to the network gutter profile.

6. The apparatus of claim 5, wherein a height of the cavity is greater than a height of the bump.

7. The apparatus of claim 5, further comprising complementary alignment features located on the first mold and the second mold.

8. The apparatus of claim 5, wherein the network of gutters defines an additional island on the mold surface on which at least one additional bump is formed, said at least one additional bump being separated from the bump having a surface with a shaped profile by the network of gutters.

9. The apparatus of claim 8, wherein the network of protuberances defining at least one additional cavity sized to overlap the at least one additional bump.

10. A method of making a shaped article, comprising:
positioning a sheet of material on a mold surface of a first mold such that a first portion of the sheet overlies a network of gutters in the mold surface and a second portion of the sheet overlies a bump on the mold surface, wherein the network of gutters defines an island on which the bump is formed and the bump has a surface with a shaped profile;
positioning a second mold having a network of protuberances defining a cavity on the sheet of material such that the network of protuberances contacts the first portion of the sheet of material and the cavity overlaps the bump; and
pressing the network of protuberances against the sheet of material, said pressing resulting in thinning out of the sheet of material between the first portion and the second portion of the sheet of material, squeezing of excess sheet of material from the thinning out into the network of gutters, and molding of the second portion of the sheet of material to the bump, thereby forming the shaped article.

11. The method of claim 10, wherein thinning out of the sheet of material comprises cutting the sheet of material between the first portion and the second portion of the sheet of material.

12. The method of claim 10, wherein the sheet of material is a sheet of glass-based material.

13. The method of claim 12, further comprising heating the sheet of material to a temperature above a softening temperature of the glass-based material prior to compressing the sheet of material.

14. The method of claim 13, further comprising cooling the shaped article to a temperature below the strain point of the glass-based material after compressing the sheet of material.

15. The method of claim 14, further comprising removing the shaped article from between the molds.

16. The method of claim 15, further comprising annealing the shaped article.

17. The method of claim 16, further comprising chemically strengthening the shaped article.

18. The method of claim 10, further comprising providing the first mold wherein the first mold is made of a material having a coefficient of thermal expansion within approximately ±1×10⁻⁶/° C. of a coefficient of thermal expansion of the sheet of material and providing the second mold wherein the second mold is made of a material having a coefficient of thermal expansion within approximately ±1×10⁻⁶/° C. of a coefficient of thermal expansion of the sheet of material.

19. The method of claim 10, further comprising providing the second mold wherein the cavity defined by the protuberance has a height that is greater than a height of the bump plus a thickness of the sheet of material.

20. The method of claim 10, wherein the protuberance penetrates the gutter during compressing the sheet of material.
